(19) United States
(12) Patent Application Publication
(10) Pub. No.: US 2019/0114573 A1
(43) Pub. Date: Apr. 18, 2019

(54) RISK SCORE CALCULATIONS FOR FACILITATION OF SAFETY TAILBOARDING

(71) Applicants: INVENTUS HOLDINGS, LLC, JUNO BEACH, FL (US); FLORIDA POWER & LIGHT COMPANY, JUNO BEACH, FL (US)

(72) Inventors: CHRISTOPHER M. MOORE, TITUSVILLE, FL (US); KEVIN M. O'DONNELL, WELLINGTON, FL (US); CLYDE E. BETHEA, III, MIDDLEBURG, FL (US); KEVIN J. HAWKER, PALM BEACH GARDENS, FL (US); ROBERT E. PORTER, III, PALMETTO, FL (US); STEVEN DUANE PULLIAM, BRADENTON, FL (US); ROY L. WEST, DAVIE, FL (US); TONY B. FREEMAN, PALM BAY, FL (US); MANUEL A. RIVERA, LAKE WORTH, FL (US)

(21) Appl. No.: 15/786,059

(22) Filed: Oct. 17, 2017

(51) Int. Cl. G06Q 10/06; G06F 9/54

(52) U.S. Cl. CPC G06Q 10/063112; G06F 9/547; G06Q 10/0635

(57) ABSTRACT

A task manager can receive protocol compliance information for a selected industrial task. The protocol compliance information includes identifiers for a set of persons executing the selected industrial task. The task manager can also query a certification database to determine if each member of the set of persons has been issued a certification corresponding to the selected industrial task. The task manager calculates a risk score for execution of the selected industrial task based on a category of the selected industrial task, the protocol compliance information and the results of the querying.

### TECHNICAL FIELD

The present disclosure relates to systems and methods for risk score calculations for facilitation of safety tailboarding.

### BACKGROUND

Occupational safety and health (OSH), also commonly referred to as occupational health and safety (OHS), occupational health, or workplace health and safety (WHS), is a multidisciplinary field concerned with the safety, health and welfare of people at work.

An occupational hazard is a hazard experienced in the workplace. Occupational hazards can encompass many types of hazards, including chemical hazards, biological hazards (biohazards), psychosocial hazards, and physical hazards. A physical hazard is a type of occupational hazard that involves environmental hazards that can cause harm with or without contact. Physical hazards include ergonomic hazards, radiation, heat and cold stress, vibration hazards and noise hazards. Engineering controls are often used to mitigate physical hazards.

Safety is a crucial operational need that effects every industry, sector and business. The importance of effective management of safety in industrial tasks can be divided into moral, legal and financial reasons. Moreover, some industrial tasks, particularly those related to electric utilities have inherent risks. In such situations, a heightened sense of awareness of safety concerns is needed.

A tailboard meeting is an informal safety meeting that may be conducted at the job site prior to the commencement of a job or work shift. During a tailboard meeting, job supervisors can draw attention to hazards, processes, equipment, tools, environment and materials to inform all workers of the risks in their surroundings.

### SUMMARY

One example relates to a non-transitory machine-readable medium having machine executable instructions. The machine executable instructions can include a task manager that receives protocol compliance information for a selected industrial task. The protocol compliance information includes identifiers for a set of persons executing the selected industrial task. The task manager can query a certification database to determine if each member of the set of persons has been issued a certification corresponding to the selected industrial task. Additionally, the task manager can calculate a risk score for execution of the selected industrial task based on a category of the selected industrial task, the protocol compliance information and the results of the querying.

Another example relates to a safety server that includes a non-transitory memory for storing machine-readable instructions and a processing unit comprising one or more processor cores that accesses the memory and executes the machine-readable instructions. The machine-readable instructions can include a task manager. The task manager includes a text parser that analyzes text generated from user input to a safety client operating on an end-user device to determine an industrial task based on keywords in the text. The task manager also include a protocol matcher that queries a protocol database for a safety protocol associated with the industrial task and the task manager provides an identifier for the industrial task and the associated safety protocol to the safety client. The task manager further includes a certification verifier that receives protocol compliance information for the industrial task that includes an identification of one or more persons executing the industrial task and determines whether the one or more persons has a certification for executing the industrial task. The task manager include a risk score calculator that calculates a risk score for execution of the selected industrial task based on the protocol compliance information and the determining by the certification verifier.

Yet another example relates to a method that includes receiving text characterizing user input that describes an industrial task. The method additionally includes identifying a given industrial task based on the text and identifying a safety protocol for the given industrial task. The method also includes providing the given industrial task and the safety protocol for the given industrial task to a safety client operating on an end-user device. The method further includes receiving protocol compliance information for the given industrial task. The protocol compliance information characterizes safety measures and persons executing the given industrial task. The method still further includes querying a certification database to determine whether each person executing the given industrial task is certified to execute the given industrial task. The method additionally includes calculating a risk score for the given industrial task. The risk score is based on the determining and the protocol compliance information.

### BRIEF DESCRIPTION OF THE DRAWINGS

FIG. 1 illustrates an example of a system for assessing and mitigating risks of industrial tasks.

FIG. 2 illustrates a screenshot of a user interface for a supervisory safety client.

FIG. 3 illustrates another screenshot of a user interface for the supervisory safety client.

FIG. 4 illustrates an example of a safety server for calculating a risk score for an industrial task.

FIG. 5 illustrates a flowchart of an example method for assessing and mitigating risks of industrial tasks.

### DETAILED DESCRIPTION

The present disclosure relates to a system for assessing and mitigating risk of industrial tasks. The system includes a graphical user interface (GUI) that allows a technician (a user) to enter information characterizing a given industrial task. The information can include keywords for the given industrial task to allow a narrowing of choices to facilitate identification of the particular task. Based on the information, the system can also retrieve a set of safety procedures and protocols for the given industrial task. For example, if the industrial task includes climbing a ladder, the system can retrieve information that explains proper techniques for resting the ladder, safety equipment (such as a harness) that should be worn while using a ladder, etc. The technician can employ the GUI to select a set of safety procedure/protocols that are being followed during execution of the given industrial task.

In some examples, the particular industrial task can identify one or more certifications that are needed to execute the industrial task. For instance, if the industrial task includes the handling of (potentially) high voltage wiring, the system can identify a technician certification (or other qualification) needed to execute the particular task. The system can query a certifications database to cross reference individuals with the certification (qualification) needed for the particular task. Based on the results, the system can determine if the user or any member of the team executing the industrial task has the needed qualifications. The results of the determination can be provided to the GUI, and the GUI can employ the results of the determination to set/adjust a risk level associated with the particular task.

The risk level characterizes a chance of an injury to the technician executing the given industrial task. The risk level is based on a plurality of factors. For example, if sufficient safety procedures are followed, an industrial task that has an initial risk score (without modifiers) of “high” may have an adjusted risk score that is “medium” or “low”. Additionally, the GUI for the technician can allow the technician to add a safety procedure/protocol for a particular task, and the system can record the added safety procedure/protocol for the particular task. Moreover, the system can be programmed to automatically (or in response to acceptance by an authorized person) add the safety procedure/protocol upon determining that a sufficiently large number of technicians have added the same (or similar) safety procedure/protocol for the particular task.

Additionally, in some situations, the given industrial task may be executed outside (e.g., utility pole maintenance). In these situations, the system can retrieve weather data for the geographic area that the industrial task is being performed. The system can analyze the information provided from the technician and the weather data to adjust the risk level for the given industrial task.

Furthermore, a supervisor of multiple technicians can employ a supervisory safety client operating on another end-user device to review a (real-time) risk level associated with industrial tasks being executed by each technician being supervised. In this manner, the supervisor can quickly assess the amount of oversight needed for each industrial task. For example, if a traditionally safe industrial activity such as electrical panel maintenance is being executed by a given technician, and the traditionally safe industrial activity has a risk level of “high”, the supervisor may presume that proper safety procedures/protocols are not being followed by the given technician. Accordingly, the supervisor could instruct the given technician on the appropriate procedure/protocol, and the risk level for the industrial activity may be updated in response to user input from the given technician. Similarly, the supervisory GUI may also reveal that another technician is executing an industrial task, such as operation of an elevated platform that has a risk level of “high” if the proper safety procedures/protocols are not followed, but the supervisory GUI reports a risk level of “low” to this instance of the industrial activity. In this situation, the supervisor may surmise that the other technician is following the appropriate safety procedures/protocols, such that the supervisor will be aware that additional oversight may not be needed. Additionally, the supervisor may receive an immediate notification that an unqualified person (a person lacking the appropriate certifications) is executing a task. Accordingly, in this situation, the Supervisor may need to re-assign someone to assist on the task. In this manner, the supervisor can efficiently direct attention to issues that need resolved.

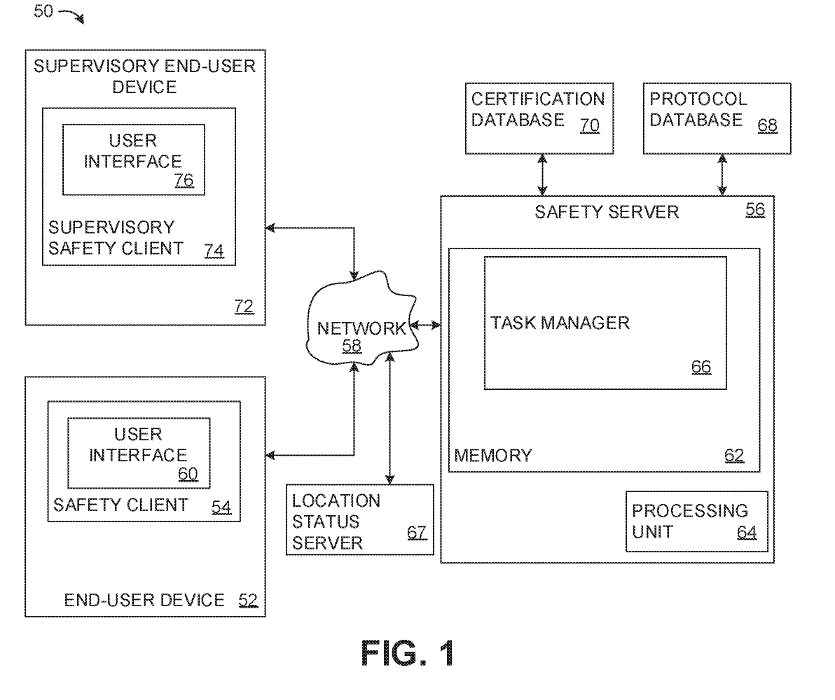

FIG. 1 illustrates an example of a safety monitoring system 50 that assesses and mitigates risks of industrial tasks. The safety monitoring system 50 could be employed at nearly any industrial facility (e.g., a power plant, a factory, a warehouse, etc.) where industrial tasks are performed. As used herein, the term “industrial task” denotes any physical task executed at the industrial facility by a human (or by multiple humans) that includes risks to bodily health if executed incorrectly.

The safety monitoring system 50 includes an end-user device 52. The end-user device 52 can be implemented as a computing device that includes a non-transitory machine-readable memory that stores machine-readable instructions and a processing unit to access the memory and execute the machine-readable instructions. The end-user device 52 could be implemented as a mobile device, such as a tablet computer, a smart phone, a laptop, etc. Alternatively, the end-user device 52 could be implemented as a stationary computer device, such as a desktop computer or a text-based terminal.

The end-user device 52 can be referred to as a “tailboarding device” that can be employed to facilitate a tailboard meeting at an industrial worksite. The end-user device 52 (a tailboarding device) can be employed to avoid tedious and repetitious meetings that might lead to complacency. The end-user device 52 includes a safety client 54 that communicates with a safety server 56 via a network 58. The network 58 could be, for example, a public network (e.g., the Internet), a private network (e.g., a carrier network or a local area network) or a combination thereof (e.g., a virtual private network). In some examples, the safety client 54 can be implemented as a stand-alone application (App). In other examples, the safety client 54 can be implemented as an applet executing on a web browser.

The end-user device 52 can include a user interface 60 for the safety client 54 that receives user input characterizing a given industrial task (e.g., during a tailboard meeting). The user input can be provided by a user, such a technician that executes industrial tasks. The user input includes keywords that attempt to identify the given industrial task. Such keywords could include, but are not limited to such as “climbing ladder”, “power-line connection”, “high-voltage power”, “hazardous material handling”, “utility pole maintenance”, etc. In some examples, the user interface 60 can be a GUI. In other examples, the user interface 60 can be a text interface, a speech-to-text interface, etc. The user interface 60 provides the user input to the safety client 54. The safety client 54 can provide task data characterizing the user input to the safety server 56 via the network 58.

The safety server 56 includes a memory 62 and a processing unit 64. The memory 62 could be implemented as volatile memory (e.g., random access memory (RAM)), non-volatile memory (e.g., a hard disk drive, a solid-state drive, flash memory, etc.) or a combination thereof. The processing unit 64 can be implemented as one or more processor cores that accesses the memory 62 and executes machine-readable instructions.

The memory 62 can include a task manager 66 that can process the task data from the safety client 54. The task manager 66 is configured/programmed to identify a given industrial task based on data (e.g., text) in the task data. The task manager 66 can be implemented, for example, as a machine learning system to identify the given industrial task based on the task data. For instance, the task manager 66 can employ a bag of words procedure, a Bayesian belief network, a neural network and/or a linear regression system to parse text in the task data to determine the given industrial task.

In some examples, the task manager 66 may provide a list of multiple industrial tasks that are each likely to be executed based on the task data. For instance, if the task data includes the terms “high voltage power connection”, the task manager 66 may determine that an industrial task of “utility pole power connection” and a utility task of “ground-based box power connection” have nearly equal chances of being the given industrial task.

Upon determining the given industrial task, the task manager 66 can query a protocol database 68 for a safety protocol for the given industrial task. As used herein, if the given industrial task requires training prior to execution, the given industrial task has an associated safety protocol. The safety protocol can define a list of procedures and/or safety measures that are to be adhered to for safe execution of the given industrial task. In some examples, there may be no safety protocol associated with the given industrial task. Additionally, the safety protocol can include information characterizing a safety record of the given industrial task. The safety record can include, for example a list of accidents (if any) that occurred during execution of the given industrial task.

The task manager 66 can return an identifier of the given industrial task (or multiple industrial tasks) and the associated safety protocol (if retrieved) to the safety client 54 of the end-user device 52. In response, the user interface 60 can output information (e.g., text and/or icons) that allow the user to select (e.g., by actuating a virtual button) the given industrial task that is to be executed. Additionally or alternatively, the user can employ the user interface 60 to select a given industrial task from a list of industrial tasks.

Upon selection of the industrial task, the safety client 54 can cause the user interface 60 to provide a questionnaire or other interactive form for the selected industrial task based on the protocol associated with the selected industrial task. The questionnaire can include a request for an identification of each person executing the selected industrial task. Further, the questionnaire can request a time, date and location of execution of the selected industrial task. Additionally, in some examples, the questionnaire can request an identification of roles each person is performing in the execution of the selected industrial task. Additionally, the questionnaire can include a link (e.g., a web link) to procedures of the selected industrial task. Moreover, the user interface 60 can provide a warning to the user if any accidents (identified in the safety record) have been recorded during execution of the selected industrial task.

The procedures for the selected industrial task can include, for example, systematic (step-by-step) instructions and/or multimedia (pictures, video and/or sound) characterizing proper procedure of the selected industrial task. For instance, if the selected industrial task includes connection of power to a ground box, the procedures can describe what precautions are needed to avoid bodily harm (e.g., electro-shock) and/or a proper order of procedures needed to avoid faults (e.g., short-circuiting a system). In some such situations, the questionnaire can include a request for confirmation that safety measures identified in the protocol associated with the selected industrial task are being followed.

As noted, in some examples, there may be no safety protocol associated with the given industrial task. Alternatively, in some situations, the user may determine that a different safety protocol is more appropriate for the selected industrial task. In such situations, the user can provide user input (e.g., text) that characterizes a particular safety protocol, which can be referred to as an added safety protocol. In response, the safety client 54 can provide data (e.g., text) identifying the added safety protocol to the task manager 66. In response to receipt of the added safety protocol, the task manager 66 can query the protocol database 68 for protocol data (e.g., safety procedures and a questionnaire) for the added safety protocol, and the task manager 66 can return the protocol data to the safety client 54 for output via the user interface 60. Additionally, the task manager 66 can store data that associates the retrieved protocol with the selected industrial task. In this manner, future queries for a protocol associated with the given industrial task may return the retrieved protocol. That is, the task manager 66 can employ machine learning such that in situations where the same protocol is selected multiple times for the given industrial task, eventually the task manager 66 selects that same protocol automatically.

Upon completion of the questionnaire, the safety client 54 can generate protocol compliance information that is provided to the task manager 66. The protocol compliance information can include, for example a list of individuals executing the selected industrial task and confirmation that safety measures are going to be properly followed, a location time, and date of execution of the selected industrial task, etc.

The task manager 66 can examine the protocol compliance information to determine a set of certifications needed to execute the selected industrial task. As used herein, the term “certification” denotes any formal or informal acknowledgement of training and abilities of an individual (or group of individuals) to execute the selected industrial task.

The task manager 66 can access a certification database 70 that contains a list of certifications for a plurality of industrial tasks, and corresponding lists of persons with each certification. The task manager 66 can cross-reference the certification database 70 to determine if one or more of the persons identified in the protocol compliance information has a certification for executing the selected industrial task.

Upon determining a certification status of each individual executing the selected task, the task manager 66 can calculate a risk score associated with execution of the selected task. The risk score can be, for example, a quantitative score (e.g., 1 to 5) and/or a qualitative score (e.g., “low risk”, “medium risk” and “high risk”). The risk score can be based on the category (type) of industrial task being executed, safety measures being followed, the protocol compliance information characterizing the results of the query to the certification database, the safety record of the selected task, etc. In particular, some tasks, such as tasks that include high voltage circuit handling include have an inherently higher risk of bodily harm than other tasks, such as painting. Such industrial tasks may be rated with a higher risk level no matter the certifications of the individuals executing the industrial task.

Furthermore, as noted, the task manager 66 bases the risk level on the number of persons executing the selected industrial task that have predetermined certifications (identified in the certification database) for executing the selected industrial task. For instance, in situations where no one that is going to execute the selected task is certified (qualified) to execute the selected task, the task manager 66 may set the risk level to a risk level of “high risk” (or a corresponding numerical value). Additionally, in situations where the selected industrial task has a large number of persons executing the selected task (e.g., six (6)) but only one (1) person has certification for executing the selected task, the task manager 66 may set the risk level to “medium risk” (or a corresponding numerical value). Similarly, in situations where the selected industrial task is being executed by a large number of persons (e.g., ten (10)), and only a small number of persons (such as one (1) or two (2)) are not certified, the task manager 66 may set the risk level to “low risk”.

Furthermore, risk level can be weighted based on the individual certifications of the persons executing the selected industrial task. In some industrial tasks, different roles have different levels of risk. For instance, if the selected industrial task includes utility pole maintenance, a first role could include handling of high voltage wiring and a second role may be limited to holding a ladder. In such a situation, the task manager 66 can apply a higher weight to the certification for the person with the first role (handling the high voltage wire) than the certification of the person assigned the second role (holding the ladder).

Still further, in some examples, the risk score can be based on environmental factors. For instance in situations where the selected industrial task is to be executed outside (e.g., utility pole maintenance) on a given date and time at a given location, the task manager 66 can query an external system (e.g., a weather information system) for weather data at the date, time and location of the selected industrial task. As one example, if the weather data indicates that rain is likely during execution of utility pole maintenance, the task manager may set the risk level of the selected industrial task to “high risk”.

In another example, the risk score can be based on location specific information provided to the task manager 66 from a location status server 67. The location status server 67 can provide information characterizing location specific status information (e.g., emergency information) that can be updated in real-time. Such information can characterize, for example, hazards that have been detected at specific locations. Thus, the risk level can be based on the status information for the location identified in the protocol compliance information. It is understood that the examples provided as the basis for the calculation of the risk level is not meant to be exhaustive. In other examples, other factors could be employed.

Upon determining the risk level, the task manager 66 can provide risk data that characterizes the risk level and risk factors for the risk level to the safety client 54 of the end-user device 52. The risk factors could be, for example, text that characterizes factors that raised or lowered the risk level. For instance, in examples where the risk level is “low risk”, risk factors could for example, indicate that all persons executing the selected industrial task are certified. Alternatively, in examples where the risk level is “medium risk”, the risk factors could indicate that although all persons are certified, the selected industrial task is inherently dangerous. As a further example, in a situation where the risk level is “high risk”, the risk factors could indicate that proper safety measures are not being followed.

In response, the user interface 60 can output the risk level and corresponding risk factors to the user of the end-user device 52. In some situations, such as situations where the risk level is “low risk” (or similar), the user may employ the user interface 60 to accept the risk level and confirm execution of the selected industrial task. In situations where the risk level of “high risk” (or similar), the user may examine the risk factors and change/update parameters of the protocol compliance data for selected industrial task for a re-calculation of the risk score. For instance, if the risk factors indicates that no one executing the selected industrial task is certified, the user may find someone that is certified, add that person to the protocol compliance data, and have the risk level re-evaluated (re-assessed). This process may be repeated until the user interface 60 receives user input indicating that the user accepts the resultant risk level. Upon acceptance of the risk level, the safety client 54 provides the task manager 66 with a confirmation that the selected task is to be executed at the accepted risk level, which selected industrial task can be referred to as a confirmed industrial task.

The safety monitoring system 50 can include a supervisory end-user device 72. The supervisory end-user device 72 can be implemented as a computing device, such as a computing device with hardware and/or software similar to the hardware and/or software implemented on the end-user device 52. Alternatively, the supervisory end-user device 72 and the end-user device 52 can be implemented with different types of hardware and/or software.

The task manager 66 can provide a supervisory safety client 74 executing on a supervisory end-user device 72 with supervisory data for the confirmed industrial task. The supervisory data can include text identifying the confirmed industrial task, the accepted risk level and risk factors for the risk level and (in some examples) the protocol compliance information. The supervisory safety client 74 can be employed by a user (e.g., a supervisor) to monitor the execution of industrial tasks by selected by the end-user device 52 and/or multiple instances of the end-user device 52. That is, the supervisory safety client 74 can be employed to monitor the execution of multiple industrial tasks executed by individuals and/or teams of individuals.

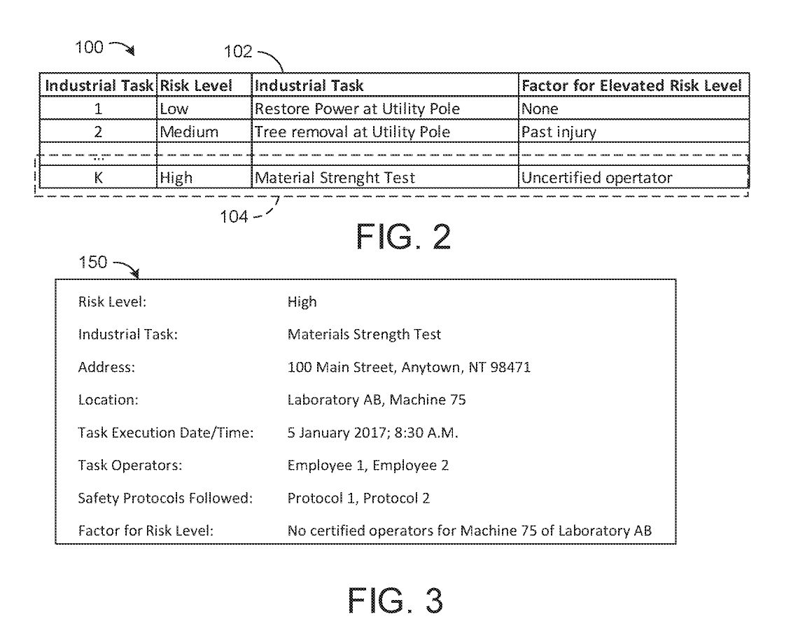

A user interface 76 (e.g., a GUI) for the supervisory safety client 74 can output information characterizing the supervisory data for K number of industrial tasks, where K is an integer greater than or equal to one. FIG. 2 illustrates an example of a screenshot 100 that could be output by the user interface 76 of the supervisory safety client 74. The screenshot 100 includes a summary table 102 for the K number of industrial tasks being monitored by the supervisory end-user device 72. The summary table 102 can include a number (or other identifier) associated with each industrial task being executed. Additionally, the summary table 102 can include a risk level associated with each industrial task, as well as a textual summary of each industrial task. Further, the summary table 102 can include a factor for an elevated risk level. In some examples, audio and/or visual indicators (e.g., an alarm and/or color-coding) can be output to signify an elevated risk level.

The user interface 76 of the supervisory safety client 74 of FIG. 1 can be configured/programmed to allow the supervisor to select (e.g., by actuating a virtual button) a particular industrial task. In the screenshot 100, it assumed that the supervisor selects the Kth industrial task, as indicated by the box 104.

Referring back to FIG. 1, upon selecting a particular industrial task, the user interface 76 of the supervisory safety client 74 can be configured to output detailed information regarding the particular industrial task. FIG. 3 illustrates an example of a screenshot 150 of information that could be output in response to selection of the Kth industrial task illustrated in FIG. 2. The screenshot 150 outputs text characterizing supervisory data regarding the particular industrial task.

Referring back to FIG. 1, the supervisor can quickly identify which (if any) industrial tasks being monitored need closer attention. Moreover, in examples where a specific industrial task needs closer attention (e.g., a “high risk” industrial task), the supervisor may contact individuals executing the specific industrial task and provide further instruction and/or personnel to change parameters in the protocol compliance information that would change the risk level associated with the specific industrial task in real-time.

Furthermore, due to environmental conditions, the risk level for the confirmed industrial task may be updated in real-time without a request from the user of the safety client 54. For example, the task manager 66 can continuously monitor the weather data and the status information from the location status server 67. If the task manager 66 receives weather data and/or status information that could change the risk level of the confirmed industrial task, the task manager 66 can provide updated risk data with the updated risk level to the safety client 54 of the end-user device 52. Similarly, the task manager 66 can provide updated supervisory data to the supervisory safety client 74.

By employing the safety monitoring system 50, the supervisor can quickly monitor a plurality of industrial tasks and divert attention to specific tasks where attention is needed/warranted. In particular, in contrast to employment of conventional paper-based records employed in some tailboard meetings, the supervisor can be assured that each industrial task is being executed in a safe manner. Alternatively, the supervisor can be warned that certain tasks are not being executed in a safe manner. In particular, the supervisor may avoid the need to monitor tasks with a first title (such as “high voltage wire connection”) that have a low risk because such tasks are executed properly and divert attention to another industrial task with a second title (such as “material strength test”) that has a high risk because it is being executed improperly. Accordingly, the supervisor can employ the supervisory safety client 74 to divide attention more efficiently, thereby mitigating risks associated with execution of the industrial tasks.

Additionally, the real-time operations and output customization provided by the safety monitoring system 50 ensures that relevant, focused information is provided to the end-users (e.g., technicians) and the supervisors. In this manner, long, tedious tailboard meetings can be avoided, and replaced with relatively quick focused tailboard meetings. Such a focus on relevancy of information dissemination can increase user-awareness to safety issues, which can increase adherence to safety procedures during execution of the industrial tasks.

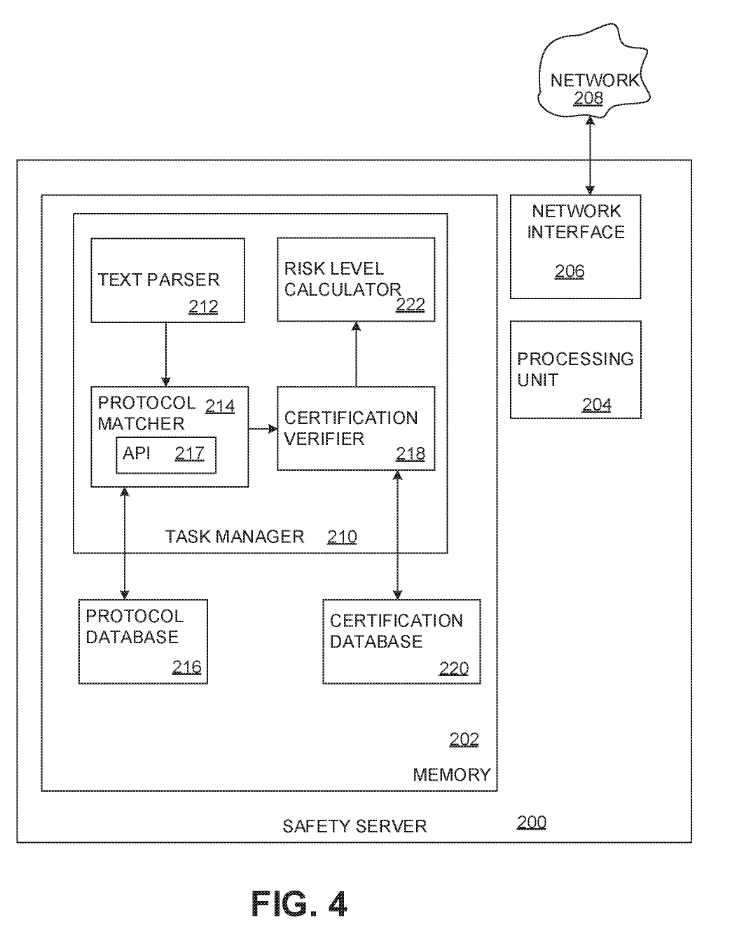

FIG. 4 illustrates an example of a safety server 200 that calculates a risk score associated with the execution of industrial tasks. The safety server 200 could be employed to implement the safety server 56 of FIG. 1. The safety server 200 can be implemented as a computing device. In particular, the safety server 200 can include a memory 202 that can store machine-readable instructions. The memory 202 could be implemented, for example, as non-transitory computer readable media, such as volatile memory (e.g., random access memory), nonvolatile memory (e.g., a hard disk drive, a solid-state drive, flash memory, etc.) or a combination thereof. The safety server 200 can also include a processing unit 206 to access the memory 202 and execute the machine-readable instructions. The processing unit 204 can include, for example, one or more processor cores. The safety server 200 can include a network interface 206 configured to communicate with a network 208. The network interface 206 could be implemented, for example, as a network interface card. The network 208 could be implemented for example, as a public network (e.g., the Internet), a private network (e.g., a local area network, a carrier network) or a combination thereof.

The safety server 200 could be implemented, for example in a computing cloud. In such a situation, features of the safety server 200, such as the processing unit 204, the network interface 206, and the memory 202 could be representative of a single instance of hardware or multiple instances of hardware with applications executing across the multiple of instances (i.e., distributed) of hardware (e.g., computers, routers, memory, processors, or a combination thereof). Alternatively, the safety server 200 could be implemented on a single dedicated computing device.

The memory 202 can include a task manager 210 that can manage industrial tasks. The task manager 210 can communicate with a safety client executing on an end-user device via the network 208. In particular, the task manager 210 can receive task data that includes a text string with keywords corresponding to an industrial task.

The task manager 210 can include a text parser 212 that can match the keywords of the task data with a potential industrial task. To identify the potential industrial task, the text parser 212 can employ machine-learning techniques, including, but not limited to a bag of words procedure, a neural network, a linear regression procedure, a Bayesian network, etc. In some examples, the text parser 212 may determine that multiple industrial tasks have a nearly equal chance of being the appropriate industrial task based on the text provided from the safety client. In such a situation, the potential industrial task can include multiple different industrial tasks. In the example illustrated in FIG. 4, the task manager 210 includes modules such as the text parser 212. However, it is understood that in some examples, such modules could be implemented as separate programs.

The text parser 212 can provide the potential industrial task to a protocol matcher 214. The protocol matcher 214 can query N number of protocol databases 216 for a safety protocol of the potential industrial task. The protocol database 216 can be implemented, for example, as a relational database, such as a search and query (SQL) database. It is understood that although the protocol database 216 is illustrated as being executed on the safety server 200, in other examples, the protocol database 216 can reside on an external computing device that communicates with the safety server 200 via the network 208.

Further, it is understood that although the protocol database 216 is illustrated as being a single database, in some examples, the protocol database 216 can be representative of a plurality of disparate systems that are operated by independent sources. In such a situation, the protocol matcher 214 can select a particular protocol database 216 (from a plurality of protocol databases 216) based on the category of the industrial task and/or other information. Additionally, in this situation, the protocol matcher 216 can include an application-programming interface (API) 217 that can format (tailor) data transmitted over a link (or multiple links) between the protocol database 216 and the protocol matcher 214.

The protocol database 216 can return a safety protocol for the potential industrial task to the protocol matcher 214. The safety protocol for the potential industrial task can include a list of procedures and/or safety measures that are to be adhered to for the safe execution of the potential industrial task. Additionally, the safety protocol can include information characterizing a safety record of the potential industrial task. The safety record can include, for example, a list of accidents that occurred during execution of the potential industrial task. Additionally, it is understood that in some situations, there may not be a safety protocol in the protocol database 216 for the potential industrial task.

The list of procedures can include, for example information (e.g., text, video and/or audio) that provides systematic (e.g., step-by-step) instructions and/or safety measures for executing the potential industrial task. The safety measures can include, for example, procedures and/or equipment employed to mitigate risk associated with the corresponding industrial task. In some examples, the protocol database 216 may provide a web link to such information.

The task manager 210 can return an identifier of the potential industrial task (or multiple potential industrial tasks) to the safety client and the associated safety protocol. Subsequently, the task manager can receive protocol compliance information and an identifier of a selected industrial task. The selected industrial task can be a user-selected (user of the safety client) instance of the potential industrial task.

Additionally, the protocol compliance information can include data that characterizes user input related to answers for a questionnaire based on the associated safety protocol for the selected industrial task. Such answers can include, for example, data characterizing a name of persons executing the selected industrial task, the roles each of the persons will execute, a time, date and location of the execution of the selected industrial task, etc. The answers can also include a list of safety measures (e.g., precautions) being followed during the execution of the selected industrial task. Such safety measures can include, for example, proper equipment, a proper number of persons executing the selected industrial task, etc.

Additionally or alternatively, the task manager 210 may receive a request to associate another safety protocol with the selected industrial task. This may occur, for example, in situations where the user of the safety client determines that the safety protocol provided with the potential industrial task is inadequate or absent. In this situation, the protocol matcher 214 can associate the other safety protocol with the selected industrial task. Moreover, the protocol matcher 214 can be a machine-learning system such that over time, multiple associations of the other safety protocol with the selected industrial task creates a stronger association between the other safety protocol and the selected task.

The task manager 210 can include a certification verifier 218 that examines the selected industrial task and the protocol compliance information based on the protocol compliance information to determine certifications needed to execute the selected task. Upon such a determination, the certification verifier 218 can query a certification database 220 and cross-reference the names of the persons executing the selected task (included in the protocol compliance information) with certifications stored in the certification database 220. The certification verifier 218 can provide certification information characterizing the results of the matching, along with the protocol compliance information to a risk level calculator 222. The certification database 220 can be a relational database, such as an SQL database. Similar to the protocol database 216, in some examples, the certification database 220 may be operating on an external computing device.

The risk level calculator 222 can determine a risk level for execution of the selected task. The risk level of the selected industrial task can define a calculated change of bodily harm occurring during execution of the selected task. As some examples, the risk level could be qualitative (e.g., “high risk”, “medium risk” and “low risk”) and/or quantitative (e.g., 1-5). It is to be understood that in other examples, other scales for the risk factor can be employed.

The risk level can be based on a plurality of factors. The factors for the risk level can be, for example, on a category (type) of the selected task. In particular, some industrial tasks, such as industrial tasks that include ladder climbing, high voltage wire handling, digging, etc. have a higher level of risk than other industrial tasks, such as meter reading, painting, etc. Additionally, the risk level can be based on the certification information. For example, if each person executing the selected task is certified to perform the assigned role of the selected task, the risk level is lower (lower risk), and if one or more persons executing an assigned role of the selected task is not certified, the risk level is higher (higher risk). The risk level can further be based on the safety measures being followed, as indicated in the protocol compliance information.

The risk level can still further be based on the safety history of the selected risk. If the same industrial task has repeatedly resulted in a bodily injury, the risk level calculator 222 can assign a higher risk level to the selected task.

Further, in some examples, the risk level calculator 222 can base the risk level on environmental factors, such as weather and/or a time of day. For instance, in situations where the industrial task requires outside work (e.g., utility pole maintenance), the risk level calculator 222 can query a weather server via the network 208 for weather information for the time and location of the selected task. As one example, in situations where the selected industrial task includes high voltage wire handling and the weather data indicates that rain is likely, the risk level calculator 222 can assign a higher risk level to the selected task.

Still further, the risk level calculator 222 can receive location status information from a location status server via the network 208. Accordingly, the risk level can be based on the location status information. For instance, if the location status information indicates that a hazard exists at a location of the selected industrial, task, the risk level calculator 222 may elevate the risk level of the industrial task.

The risk level calculator 222 can generate risk data that characterizes the calculated risk level for the selected industrial task. Additionally, the risk data can include risk factors (text) characterizing a factors that raised and/or lowered the risk level for the selected risk. The risk level calculator 222 can provide the risk data to the safety client via the network 208.

In response, the task manager 210 may receive updated protocol compliance information requesting a re-calculation of the risk level. In response to the updated protocol compliance information, the risk level calculator can re-calculate the risk level for the selected industrial task that is provided to the safety client. This process can be repeated multiple times until a confirmation that the selected task is to be executed, which can be referred to as a confirmed industrial task.

Upon receipt of confirmation, the task manager 210 can generate supervisory data for a supervisory safety client executing on a supervisory end-user device (e.g., the supervisory end-user device 72 of FIG. 1). The supervisory data can include information characterizing the confirmed industrial task, along the protocol compliance information and the risk score associated with the confirmed industrial task. The supervisory data can be provided to the supervisory end-user device via the network 208.

It is understood that in some examples, the supervisory safety client may receive supervisory data for a plurality of different industrial tasks. In this manner, the supervisor (user) using the supervisory safety client can focus attention on the industrial tasks that have an elevated risk score (e.g., “medium risk” or “high risk”). Moreover, in some situations, after receiving notification that a given confirmed industrial task has an elevated risk score, the protocol compliance information for the confirmed industrial task may be updated, and the risk level calculator 222 can re-calculate the risk score for that given confirmed industrial task. In this manner, the safety server 200 can update the supervisory data in real-time.

Furthermore, the risk level calculator 222 may update the risk level for the confirmed industrial task in real-time automatically (e.g., without a request from the safety client). For example, the risk level calculator 222 can continuously monitor the weather data and/or the location status information to determine if an update to the risk level is needed. Upon determining that the risk level for the confirmed industrial task is warranted, the risk level calculator 222 can generate an updated risk level for the confirmed task. Accordingly, risk data and supervisory data that characterizes the updated risk level can be provided to the safety client and the supervisory safety client, respectively.

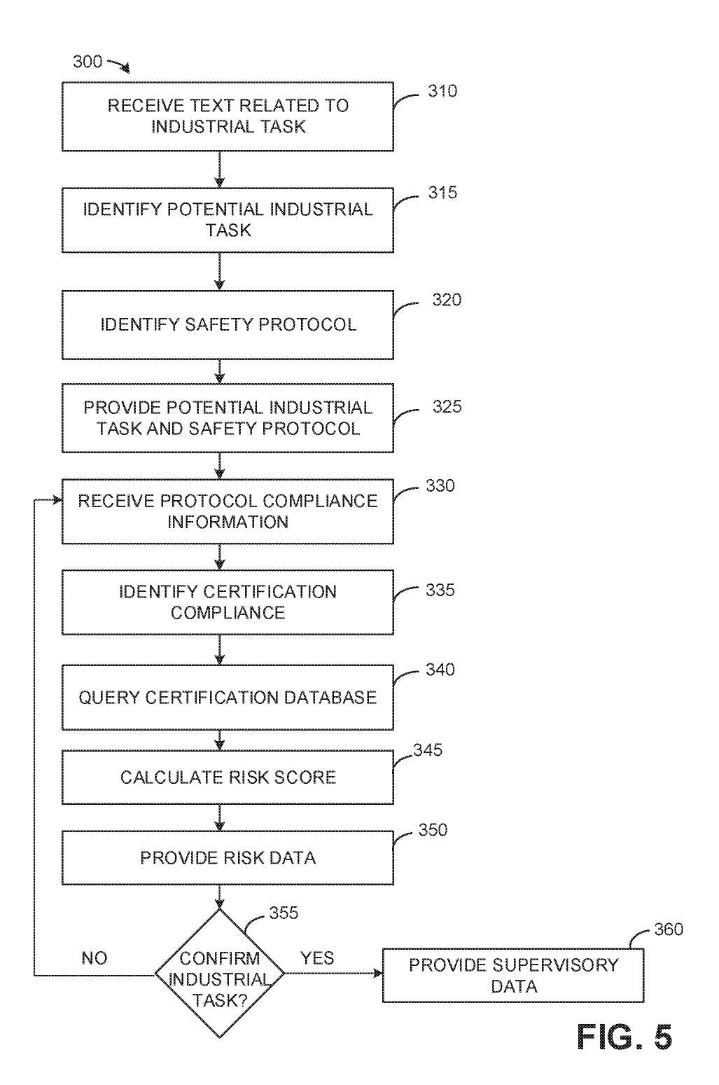

In view of the foregoing structural and functional features described above, an example method will be better appreciated with reference to FIG. 5. While, for purposes of simplicity of explanation, the example method of FIG. 5 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 5 illustrates a flowchart of an example method 300 for monitoring and mitigating risks associated with the execution of industrial tasks. The method 300 could be implemented, for example, by the safety monitoring system 50 of FIG. 1 and/or the safety server 200 of FIG. 4.

At 310, a task manager (e.g., the task manager 66 of FIG. 1) executing on the safety server can receive text (task data) corresponding to user input at a safety client (e.g., the supervisory safety client 74 of FIG. 1). The text can include keywords corresponding to an industrial task. At 315, the task manager can identify a potential industrial task based on the keyword in the text. At 320, the task manager can query a protocol database (e.g., the protocol database 68) to identify a safety protocol associated with the potential industrial task. At 325, the task manager can provide the potential industrial task to the safety client.

At 330, the task manager can receive protocol compliance information along with a selection of the potential industrial task. The protocol compliance information characterizes answers to a questionnaire related to details of execution of the selected industrial task. At 335, the task manager can parse the protocol compliance information to identify certifications associated with the selected task. At 340, the task manager can query a certification database to determine whether persons executing the selected industrial task have been certified. At 345, the task manager can calculate a risk score based on the protocol compliance information and the request of the query of the certification database. As discussed herein, the risk score can also be based on external factors, such as weather.

At 350, the task manager can provide the risk data to the safety client. The risk data can include the risk score, along with factors that affected the risk score. At 355, a determination can be made as to whether the task manager receives confirmation that the selected industrial task is to be executed (as a “confirmed industrial task”). If the determination at 355 is negative (e.g., “NO”), the method 300 can return to 330. If the determination at 355 is positive (e.g., “YES”) the method can proceed to 360. At 360, the task manager can provide supervisory data for the confirmed industrial task to a supervisory safety client (e.g., the supervisory safety client 74 of FIG. 1) operating on a supervisory end-user device 72. The supervisory data can include an identifier of the confirmed industrial task, the risk level for the confirmed industrial task, factors affecting the risk level and the protocol compliance information for the confirmed industrial task, etc.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A non-transitory machine-readable medium having machine executable instructions, the machine executable instructions comprising a task manager that:
receives protocol compliance information for a selected industrial task, wherein the protocol compliance information includes identifiers for a set of persons executing the selected industrial task;
queries a certification database to determine if each member of the set of persons have been issued a certification corresponding to the selected industrial task; and
calculates a risk score for execution of the selected industrial task based on a category of the selected industrial task, the protocol compliance information and the results of the querying.

2. The medium of claim 1, wherein the risk score is further based on weather data for a time corresponding to a time and location of execution of the selected industrial task.

3. The medium of claim 1, wherein the task manager provides risk data that characterizes the calculated risk score to a safety client operating on a given end-user device.

4. The medium of claim 3, wherein the task manager receives confirmation of execution of the selected industrial task to form a confirmed industrial task and the task manager provides supervisory data to a supervisory safety client operating on another end-user device, and the supervisory data characterizes the confirmed industrial task and the risk score.

5. The medium of claim 4, wherein the supervisory data further characterizes at least one factor that affected the risk score.

6. The medium of claim 5, wherein the at least one factor includes information indicating that no member in the set of persons executing the confirmed industrial task is certified to execute the confirmed industrial task.

7. The medium of claim 1, wherein the task manager receives text comprising keywords based on user input and matches the text with the selected industrial task.

8. The medium of claim 7, wherein the matching is based on a machine-learning process that includes at least one of a bag of words procedure, a Bayesian belief network, a neural network and a linear regression procedure.

9. The medium of claim 7, wherein the task manager queries a protocol database to retrieve a protocol associated with the selected industrial task.

10. The medium of claim 1, wherein the task manager receives a request to associate a given protocol with the selected industrial task.

11. A safety server comprising:
a non-transitory memory for storing machine-readable instructions; and
a processing unit comprising one or more processor cores that access the memory and executes the machine-readable instructions, the machine-readable instructions comprising:
a task manager comprising:
a text parser that analyzes text generated from user input to a safety client operating on an end-user device to determine an industrial task based on keywords in the text;
a protocol matcher that queries a protocol database for a safety protocol associated with the industrial task, wherein the task manager provides an identifier for the industrial task and the associated safety protocol to the safety client;
a certification verifier that:
receives protocol compliance information for the industrial task that includes an identification of one or more persons executing the industrial task; and
determines whether the one or more persons has a certification for executing the industrial task; and
a risk score calculator that calculates a risk score for execution of the selected industrial task based on the protocol compliance information and the determining by the certification verifier.

12. The system of claim 11, wherein the certification verifier examines the industrial task to determine a certification needed for each of a plurality of roles of the industrial task and queries a certification database to determine if the one or more persons identified in the protocol compliance information is certified to execute each of the plurality of roles of the industrial task.

13. The system of claim 11, wherein the protocol compliance information indicates that the industrial task is executed outside at a given time and date at a given location, and the risk score is further based on weather data for the given location at the given time and date, and wherein the risk level is updated in response to detecting a change in the weather data.

14. The system of claim 11, wherein the task manager receives confirmation from the safety client that the industrial task is going to be executed and the task manager provides supervisory data to a supervisory safety client characterizing the confirmed industrial task and the risk score.

15. The system of claim 11, wherein the risk score is further based on a safety record of the industrial task.

16. The system of claim 11, wherein the protocol matcher comprises an application-programming interface (API) that formats data transmitted between the protocol database and the protocol matcher, wherein the protocol database is operated independently of the safety server.

17. The system of claim 11, wherein the user input is provided to the end-user device via speech-to-text.

18. The system of claim 11, wherein the risk score is based on location status information for a location associated with the selected industrial task, and wherein the risk level is updated in response to detecting a change in the location status information.

19. A method comprising:
receiving text characterizing user input that describes an industrial task;
identifying a given industrial task based on the text;
identifying a safety protocol for the given industrial task;
providing the given industrial task and the safety protocol for the given industrial task to a safety client operating on an end-user device;
receiving protocol compliance information for the given industrial task, wherein the protocol compliance information characterizes safety measures and persons executing the given industrial task;
querying a certification database to determine whether each person executing the given industrial task is certified to execute the given industrial task; and
calculating a risk score for the given industrial task, wherein the risk score is based on the determining and the protocol compliance information.

20. The method of claim 18, further comprising providing supervisory data that identifies the given industrial task, the risk score and at least one factor that affected the risk score.
